(19) United States
(12) Patent Application Publication
(10) Pub. No.: US 2010/0320964 A1
(43) Pub. Date: Dec. 23, 2010

(54) Method And System To Charge Batteries Only While Vehicle Is Parked

(75) Inventors: James A. Lathrop, Saline, MI (US); Karin Lovett, Novi, MI (US); Thomas M. Gwozdek, Plymouth, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Global Technologies, LLC, Dearborn, MI (US)

(21) Appl. No.: 12/487,072

(22) Filed: Jun. 18, 2009

(51) Int. Cl. H02J 7/00

(52) U.S. Cl. 320/109

(57) ABSTRACT

Electric vehicles and plug-in hybrid electric vehicle derive all, or at least some, of their power from the electrical grid. The vehicle is provided with a receptacle into which a 110 Volt AC power cord can be plugged. According to the present disclosure, coupling of the external power supply and/or charging are prevented when the vehicle is not in a parked condition. The parked condition is based on the application of a vehicle parking brake and/or a gear shift selector being in a parked position. If a parked condition is not detected, one of the following measures is taken: a relay in the battery charger on board the vehicle is opened thereby disallowing charging; an access door to the receptacle is locked by an access door solenoid; and a plug ejector prevents insertion of a plug into the receptacle.

### BACKGROUND

1. Technical Field

The present disclosure relates generally to charging batteries on-board automotive vehicles.

2. Background Art

In response to concerns about dwindling petroleum supplies, manufacturers of automotive vehicles are developing hybrid electric vehicles, electric vehicles, and plug-in hybrid electric vehicles (PHEVs), the latter two deriving all or some of their power from an electrical grid during charging of an onboard battery pack. Obtaining a charge from an electrical grid is normally accomplished when the vehicle is not operating. It would be desirable to ensure that the vehicle is properly parked prior to initiating charging of the battery pack.

### SUMMARY

The invention includes a system and method for charging batteries onboard a vehicle where charging of the batteries is allowed only when the vehicle is in a parked condition.

The vehicle is in a parked condition when the gear shift selector is in park. The gear shift selector actuates a pawl to engage with a parking gear wheel on the driveline of the vehicle. When the pawl is engaged with a tooth of the parking gear wheel, rotation of the parking gear wheel and the driveline component to which it is coupled is prevented. Alternatively, the vehicle is determined to be parked when a parking brake is applied.

When the vehicle is in the parked condition, plugging in an external power supply cord into the vehicle's receptacle is allowed to proceed uninterrupted. However, if the vehicle operator attempts to commence charging without having first put the vehicle in park, charging is prevented. In one embodiment, an access door to the receptacle is locked shut. In another embodiment, a plug ejector or plug preventer pin coupled to the receptacle prevents coupling of a plug with the receptacle. In another embodiment, the plug is allowed to be coupled with the receptacle, but current flow is prevented by opening a relay within a battery charger on the vehicle.

An operator of an electric vehicle depends on the ability to charge the batteries from an external power source to have continued use of the vehicle. Because charging takes hours, it occurs usually while the operator is away from the vehicle. The present development provides an advantage by ensuring that an operator has placed the vehicle in an immovable state prior to commencing charging. This prevents unintended movement of the vehicle while it is coupled to an external power source.

According to an embodiment of the disclosure, the operator is informed that charging is not occurring and, in some embodiments, is provided with information as to why charging is not occurring, if that is the case. This provides the operator an opportunity to take measures to place the vehicle in a parked condition so that charging can commence. This presents an advantage over a system that provides no information to the vehicle operator when the operator is under the impression that charging is occurring only to find hours later that charging was not occurring due to a failure to properly park the vehicle.

### BRIEF DESCRIPTION OF THE DRAWINGS

FIG. 1 is a schematic representation of a plug-in hybrid electric vehicle;

FIG. 2 is a schematic representation of a disc braking system;

FIG. 3 is a schematic representation of en electric vehicle;

FIG. 4 is a schematic representation of embodiments of the present disclosure;

FIG. 5 is a representation of a receptacle configuration according to an alternative embodiment of the present disclosure; and

FIGS. 6 and 7 are flowcharts of embodiments of the present disclosure.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

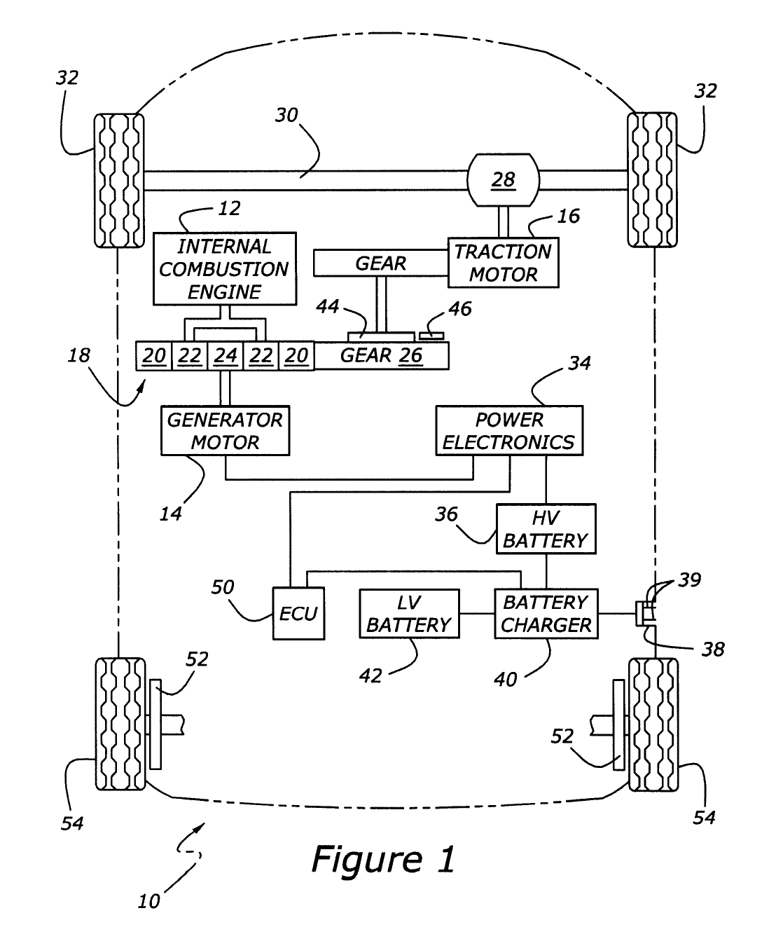

An example configuration of a PHEV 10 is shown schematically in FIG. 1. PHEV 10 has at least two propulsion sources: an internal combustion engine 12 and a generator motor 14. In one embodiment, traction motor 16 may also be used to propel PHEV 10. Engine 12 and generator motor 14 are coupled to transmission 18. In one exemplary configuration, transmission 18 is a planetary gear set having a ring gear 20, planetary gears 22, and sun gear 24 with planetary gears 22 coupled to engine 12 and sun gear 24 coupled to generator motor 14. Ring gear 20 is coupled to a gear 26. Gear 26, differential 28, and half shafts 30 can be considered the final drive. Half shafts 30 are connected to driving wheels/tires 32.

FIG. 1 also schematically illustrates the major electrical components in PHEV 10. Generator motor 14 and traction motor 16 interact with power electronics 34. Both generator motor 14 and traction motor 16 can be operated in a mode in which electrical energy is converted into mechanical energy and a mode in which mechanical energy is converted into electrical energy. The reservoir for the electrical energy is the high voltage battery 36. High voltage battery 36 can be supplied electrical energy from an external source via receptacle 38 with a battery charger 40 converting an AC supply to DC for battery storage. Typically, PHEV 10 also includes a low voltage battery 42 to power vehicle accessories such as lights, gauges, etc. PHEV 10 has an electronic control unit (ECU) electronically coupled to at least power electronics 34 and battery charger 40.

To lock the final drive when the car is placed in park, a parking gear wheel 44 is provided. In FIG. 1, parking gear wheel 44 is coupled to gear 26 such that when parking gear wheel 44 is locked, gear 26 is also locked thereby locking wheels/tires 32. Rotation of parking gear wheel 44 is prevented when parking pawl 46 is pressed in between two teeth of parking gear wheel 44. As shown in FIG. 1, parking pawl 46 is disengaged from parking gear wheel 44 thereby allowing free rotation of gear 26, differential 38, half shafts 30 and wheels/tires 32. A parking pawl is described in more detail in U.S. Pat. No. 4,722,427 that is incorporated by reference herein in its entirety.

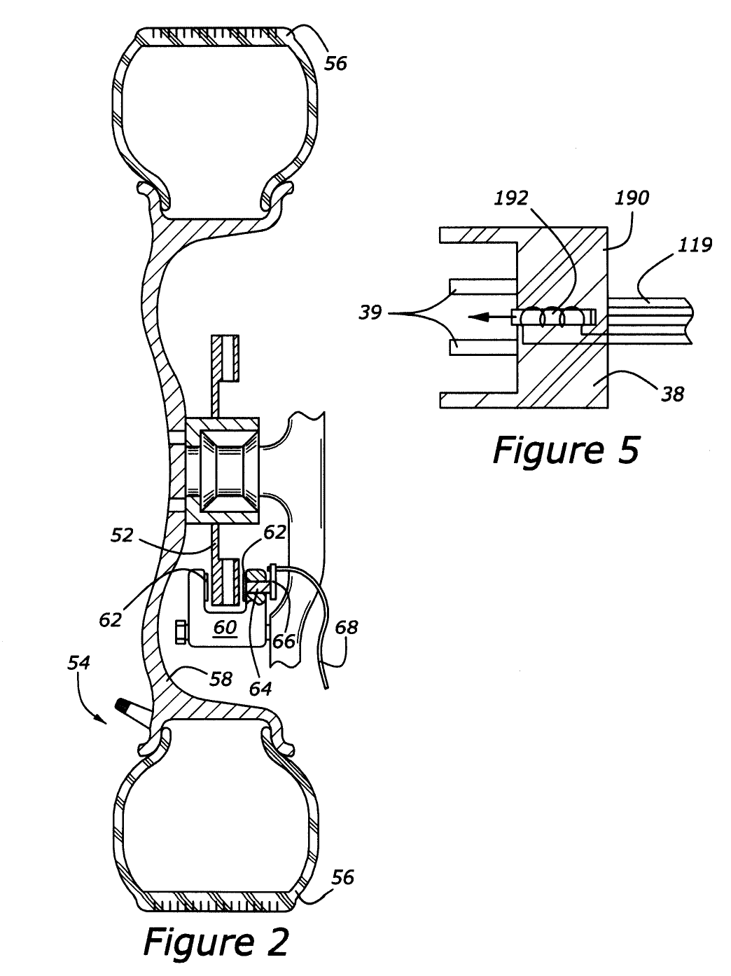

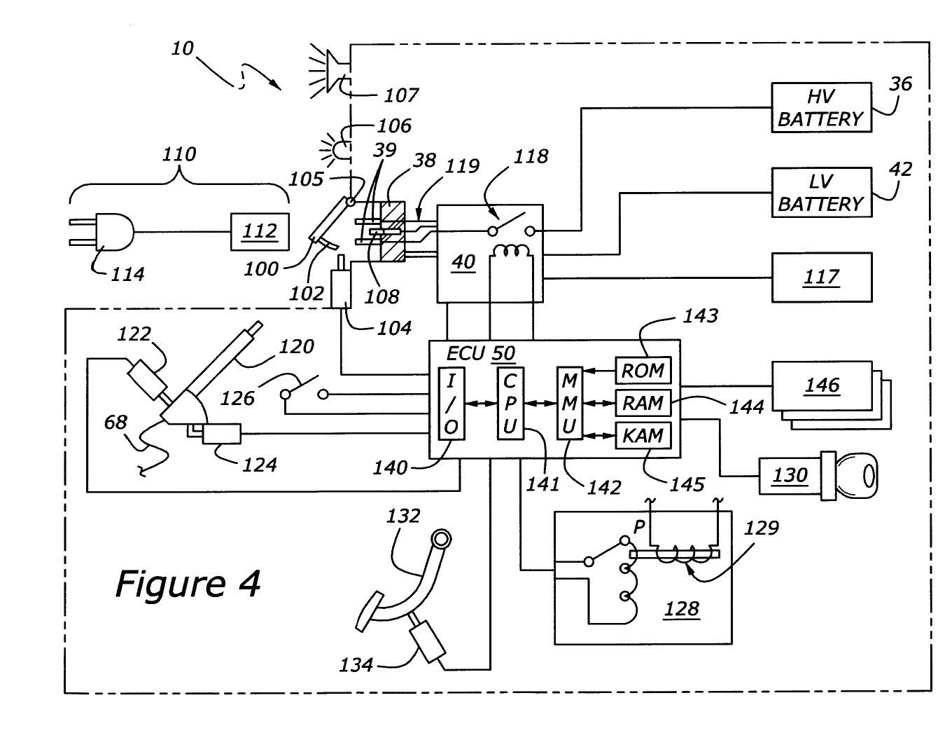

Also shown in FIG. 1 are discs 52 coupled to non-driving wheels/tires 54. Referring now to FIG. 2, a single wheel/tire 54 is shown in cross-section providing more detail. Tire 56 is mounted on wheel 58. Disc 52 is coupled to wheel 58. A caliper 60 has brake pads 62. When the pads 62 of caliper 60 are squeezed toward disc 52, pads 62 contact disc 52. When disc 52 is rotating, the friction between pads 62 and disc 52 cause disc 52 to decelerate thereby braking the rotation of wheel 58. In typical service, pads 62 are acted upon by hydraulically-actuated cylinders (not shown in FIG. 2). These are known by one skilled in the art as service brakes. It is also known to provide an emergency or parking brake. A threaded actuator 64 is provided in caliper 60. Actuator 64, when rotated, causes pads 62 to grip disc 52. Actuator 64 is rotated when crank arm 66 is caused to rotate. Crank arm 66 is attached to a cable 68 which is coupled to a hand brake lever or foot pedal (discussed in more detail in conjunction with FIG. 4) in the vehicle cabin. The operator of the vehicle can set the parking brake, typically, by pulling up on a hand operated lever or by depressing a foot pedal. The parking brake is also released under operator action.

In another alternative, an electric parking brake is provided on the vehicle. An example electric parking brake configuration is shown in U.S. Patent Application Publication No. 2006/0151260 A1 that is incorporated by reference herein in its entirety.

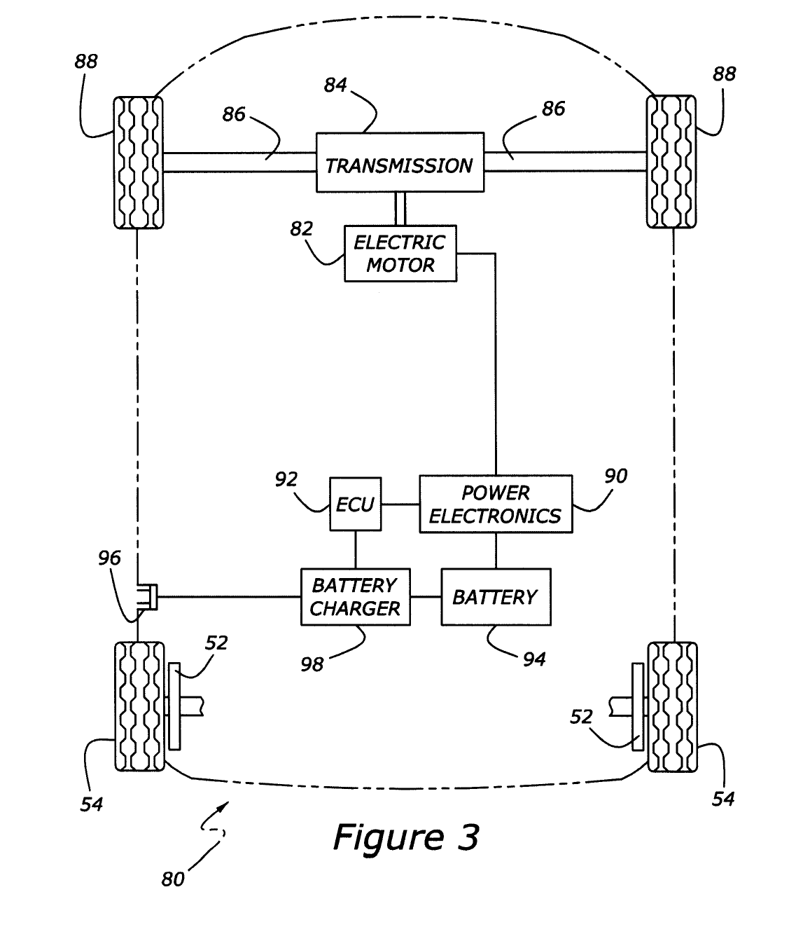

In FIG. 3, an electric vehicle 80 is shown propelled by an electric motor 82 mechanically coupled to a transmission 84, half shafts 86, and wheels/tires 88. Electric motor 82 is electrically coupled to power electronics 90 that is controlled by ECU 92. Power electronics 90 is coupled to high voltage battery 94. Battery 94 is charged from an external source through receptacle 96 and battery charger 98. Battery charger is also controlled by ECU 92.

In FIG. 4, the hardware relevant to some embodiments of the present disclosure is represented schematically. Receptacle 38 is provided on PHEV 10 on an operator-accessible surface of PHEV 10. Alternatively, FIG. 4 can represent an electric vehicle, according to an embodiment of the disclosure. Receptacle 38 is protected from ambient contaminants, such as water and dirt, by access door 100. A latch 102 on door 100 prevents door 100 from being opened when access door release solenoid 104 engages with latch 102 and door 100 is closed. Furthermore, an access door switch 105 cooperates with door 100 to provide a signal to ECU 50 whether door 100 is closed or not. Access door switch 105 can be: a rotary switch detecting when access door 100 is at an angle indicating it is closed, a pin switch placed near door 100 with door 100 depressing the pin switch when substantially closed, or any other known switch type. Near door 100 is an indicating light 106, which in one embodiment, is illuminated to indicate charging. Many alternatives to an indicating light 106 may be found useful: multiple lights (such as LEDs) in a variety of colors indicating such things as: charging complete, charging in process, a fault in the charging system, charging is not taking place, etc. In yet another alternative, a single indicating light 106 may be used to indicate various conditions by employing flashing patterns. Indicating light 106, in other embodiments, is located anywhere on PHEV 10. Alternatively, or additionally, a speaker 107 supplies a beeping signal to alert the operator to various conditions listed above. In yet another alternative, speaker 107 provides output of recorded speech to indicate the condition to the operator. In one embodiment, receptacle 38 also has a pin switch 108, which is depressed and sends a signal to ECU 50 when a plug is coupled with receptacle 38.

Also shown in FIG. 4 is an external power supply cord 110, which is external to PHEV 10. Cord 110 comprises a plug 112, which can be coupled with receptacle 38, and plug 114, which is a standard plug that can be plugged into a standard 110 Volt outlet. Receptacle 38 is shown having two prongs in a non-limiting example. Receptacle 38 may include ground and sensor prongs.

Also shown in FIG. 4 is battery charger 40 which charges high-voltage battery 36 and/or low-voltage (standard 13.8 V) battery 42. Battery charger 40, in some embodiments, may provide power to other engine accessories 117 such as an engine block heater. In one embodiment, battery charger 40 includes an internal relay 118. When relay 118 is open, charging of high voltage battery 36 is prevented. A control signal from ECU 50 can be supplied to relay 118, the control signal either closing relay 118 to allow charging when ECU 50 determines that conditions are appropriate for charging or opening relay 118 to prevent charging when ECU 50 determines conditions are inappropriate.

According to an embodiment of the present disclosure, several paths of communication between ECU 50 and electrical switches, indicators, or actuators associated with receptacle 38 are formed: ECU 50 is provided a signal concerning whether plug 112 is coupled with receptacle 38; ECU 50 is provided a signal from access door switch 105 concerning whether access door 100 is open or closed; ECU 50 controls indicating light 106; and ECU 50 controls access door release solenoid 104. The electrical conductors between ECU 50 and these elements associated with access door 100, in one embodiment, are directly connected, shown, for example, in regards to access door release solenoid 104. In another embodiment, these conductors are coupled to ECU 50 via battery charger 40, i.e., through a wiring harness 119 to battery charger 40 that is coupled to ECU 50.

Continuing to refer to FIG. 4, PHEV 10 has a parking brake (also referred to as an emergency brake). Brake lever 120 is set and released under operator control. Brake lever 120, as shown in FIG. 4, is a hand brake that pulls on cable 68 when pulled upward. (The other end of cable 68 is shown in FIG. 2.) Alternatively, the parking brake is controlled by a foot pedal. A switch 122 is activated when brake lever 120 is applied. A signal from switch 122 is provided to ECU 50 to indicate whether the parking brake is set. In one embodiment, a parking brake lock solenoid 124 is actuated under control by ECU 50. It is known in the art to have an electric parking brake, which can be controlled either by an operator-controlled switch 126 or under control of ECU 50.

Also shown in FIG. 4 is a gear shift selector 128 for an automatic transmission vehicle. As discussed above in regards to FIG. 1, a parking gear wheel 44 and parking pawl 46 are provided on the vehicle. Pawl 46 engages with a tooth on parking gear wheel 44 when the P, or park, position of gear shift selector 128 is selected by the operator. Gear shift selector 128 is coupled via linkages (not shown) to pawl 46. Pawl 46 is disengaged from parking gear wheel 44 in any other setting of gear shift selector 128. The status of gear shift selector 128 is communicated to ECU 50.

An ignition key switch 130 is also shown in FIG. 4 communicating with ECU 50. The intention of the vehicle operator to drive away is sensed by the key being inserted and turned to the key on position. In vehicles equipped with automatic transmissions, it is common for engine starting to be predicated on the operator depressing a brake pedal 132 as well as putting ignition key switch 130 in the key on position. Brake pedal 132 closes a switch 134 communicating with ECU 50.

ECU 50 I/O 140, CPU 141, MMU 142, ROM 143, KAM 144, RAM 145, and other accessories 146. Continuing to refer to FIG. 1, electronic control unit (ECU) 50 is provided to control engine 40 and components of the vapor recovery system. ECU 50 has a microprocessor 62, called a central processing unit (CPU) 141, in communication with memory management unit (MMU) 142. MMU 142 controls the movement of data among the various computer readable storage media and communicates data to and from CPU 62. The computer readable storage media preferably include volatile and nonvolatile storage in read-only memory (ROM) 143, random-access memory (RAM) 144, and keep-alive memory (KAM) 145, for example. KAM 155 may be used to store various operating variables while CPU 62 is powered down. The computer-readable storage media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by CPU 141 in controlling the engine, charging system, and vehicle. CPU 141 communicates with various sensors and actuators 146 via an input/output (I/O) interface 140. Some ECU 50 architectures do not contain MMU 142. If no MMU 142 is employed, CPU 141 manages data and connects directly to ROM 143, RAM 144, and KAM 145. Of course, the present disclosure could utilize more than one CPU 141 to provide engine control and ECU 50 may contain multiple ROM 143, RAM 144, and KAM 145 coupled to MMU 142 or CPU 141 depending upon the particular application.

According to an embodiment of the present disclosure, PHEV 10 is prevented from drive away or from rolling away when external power cord 110 is plugged into receptacle 38 or charging is occurring. There are several alternative indicating conditions indicating charging and/or an external cord is attached to PHEV10:
1) a signal from pin switch 108 indicates when plug 112 (of external power supply cord 110) is depressing switch 108;
2) a signal from access door switch 105 indicates that access door 100 is open. (It is possible, of course, for door 100 to be open without a plug being coupled to receptacle 38. It might be useful to provide a warning light or sound to indicate that the vehicle is not operable until access door 100 is closed);
3) a determination that current is flowing to or through battery charger 40; and/or
4) a determination that a voltage source is coupled to receptacle 38.

If a condition is determined indicating that an external supply cord 110 is coupled with receptacle 38, the vehicle will be prevented from driving or rolling away by:
1) preventing the parking brake from being released; and/or
2) preventing gear shift selector 128 from moving from a parked position.

The parking brake may be a traditional hand or foot operated parking brake that is connected to a cable 68 which acts upon pads 62 to restrain at least one wheel of the vehicle from operating. Alternatively, an electric parking brake can be employed. In yet another alternative, an anti-lock brake system of the vehicle can be employed to act as a parking brake. Gear shift selector 128, in a typical automatic-transmission equipped vehicle, is linked to a pawl 46 which engages with parking gear wheel 44 (coupled to the transmission) when in a park position. When pawl 46 is engaged with parking gear wheel 44, the transmission is prevented from moving. In the present disclosure, parking gear wheel 44 is coupled to the transmission in one embodiment. However, parking gear wheel 44 may be coupled to any driveline component of the vehicle that prevents rotation of the wheels when locked. Depending on the vehicle architecture, the driveline may include: a transmission, a driveshaft, a differential (a type of transmission), and the wheels. Herein, the driveline refers to components, which is locked in place, lock at least one wheel of the vehicle. Note that in typical automatic-transmission equipped vehicles, the vehicle operator is unable to remove the key from the vehicle when the gear shift selector 128 is not in park. Thus, it is likely that the vehicle operator encounters the car with gear shift selector 128 already in park. Unless the key has been left in the ignition.

Vehicles equipped with manual transmissions typically do not have a parking gear wheel 44 and pawl 46. However, it is possible to provide such equipment on a manual-transmission vehicle. If this were the case, the manual-transmission equipped vehicle can be restrained in a fashion similar to that of an automatic-transmission equipped vehicle.

Anti-lock braking systems (ABS) operate by applying the service brakes under control by ECU 50. The ECU commands application of hydraulic pressure to hydraulic cylinders acting on brake pads 62. In normal service, the hydraulic pressure is applied by the operator depressing a brake pedal 132. When wheel slippage is sensed, ECU 50 can apply hydraulic pressure independently of the operator control. Normally, ABS braking is pulsated when activated during driving. According to an embodiment of the present disclosure, the ABS can be used as a parking brake alternative. An ABS system is described in U.S. Pat. No. 5,403,078 and incorporated by reference herein in its entirety.

In other embodiments, charging is prevented when the vehicle has not been parked. PHEV 10 is determined to be parked when gear shift selector 128 is placed in the park position, thereby causing pawl 46 to engage with parking gear wheel 44. Alternatively, pawl 46 is caused to engage with parking gear wheel 44 by another actuator than a gear shift selector. In yet another embodiment, a parked condition is based on whether a parking brake is set thereby preventing rotation of at least one of the vehicle's wheels. The parking brake can be a standard hand or foot operated brake. In such case, a brake set switch provides an indication to ECU 50 that the parking brake is set. Alternatively, an electric park brake is applied either under operator control by operator activation of a switch or under control by ECU 50. In either case, ECU 50 is provided a signal indicating that electric park brake is set. In yet another alternative, an ABS system can be used in a parking brake mode.

Only when the vehicle is determined to be parked does ECU 50 allow charging. In one embodiment, ECU allows access door 100 to open by commanding access door release solenoid 104 to an unlocked position thereby allowing external power supply cord 110 to couple with receptacle 38. In another embodiment, external power supply cord 110 is able to couple with receptacle 38 whether or not the vehicle is parked. However, battery charger 40 is provided with a relay 118, which is closed under control of ECU 50 only when ECU 50 determines that PHEV 10 is in a parked condition. In one embodiment, an indicating light flashes or a speaker beeps to indicate to the operator that although the external power supply cord 110 is coupled with receptacle 38, charging is not occurring.

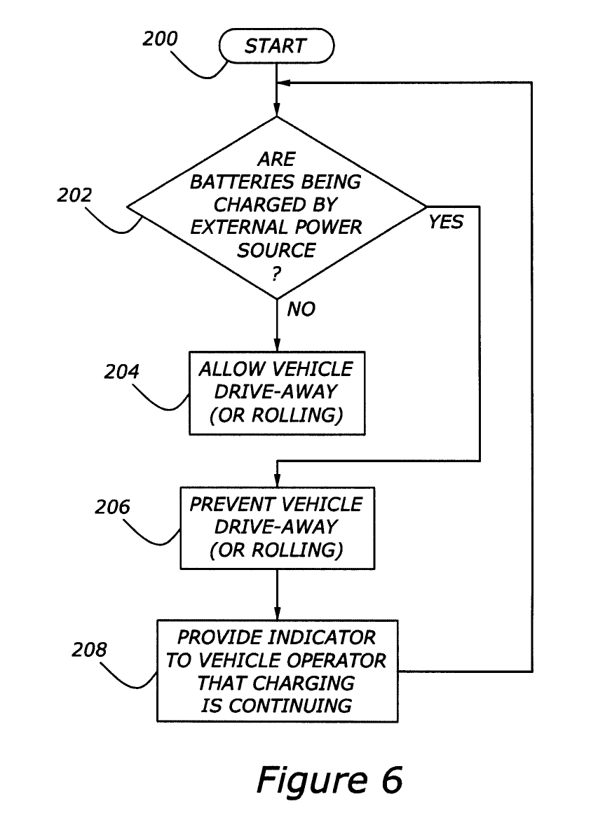

In yet another alternative shown in FIG. 5, receptacle 38 is provided with a plug ejector 188. When an operator attempts to couple an external power supply cable 110 to receptacle 38 when PHEV is not parked, solenoid 190 is activated so that pin 192 of solenoid 190 retracts outward ejecting a plug (such as 112 in FIG. 4). Only when PHEV 10 is parked, does solenoid 190 remain in the position shown in FIG. 5 which allows coupling of a plug with receptacle 38. Alternatively to acting as a plug ejector, solenoid 190 may act as a plug preventer by being actuated to its extended position to prevent coupling of a plug with receptacle 38 prior to a plug in attempt.

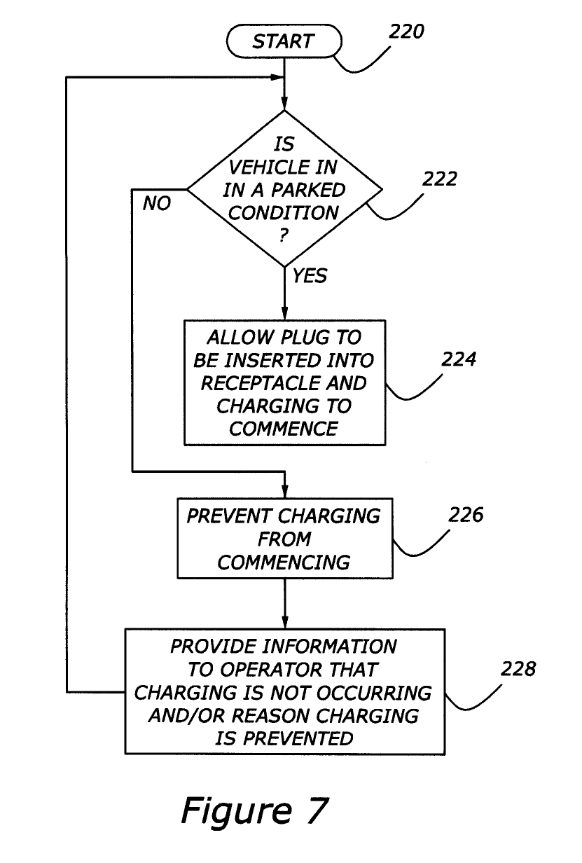

In FIG. 6, a flowchart illustrates an embodiment of the present disclosure. After starting 200 the algorithm, it is determined in 202 whether the batteries are being charged by an external power source 202. Several methods and systems to indicating this are described above. If charging is not occurring, then drive away or roll away of the vehicle is allowed in 204. If charging is detected in 202, control passes to 206 in which the vehicle is prevented from moving; several methods and system to do so are described above. Control passes to 208 in which an indication is provided to the operator indicating that charging is continuing, possibly indicating that the cord is still connected. Control passes continues to pass back to 202 until charging is no longer detected.

In FIG. 7, a flowchart illustrates an embodiment of the present disclosure starting at 220. Control passes to 222 where it is determined whether the vehicle is in a parked condition (systems and methods for making such a determination are discussed above). If the vehicle is parked, control passes to 224 and coupling of the plug and commencing of charging are allowed. If the vehicle is determined not to be parked in 222, control passes to 226 in which charging is prevented (systems and methods for doing do are discussed above). Control passes to block 228 in which information to the vehicle operator is provided to indicate that charging is not occurring and/or the reason that charging cannot be initiated. If the vehicle operator attends to the matter preventing charging, the next time control passes to block 222, a positive result results and control passes to block 224 allowing charging.

While the best mode has been described in detail with respect to particular embodiments, those familiar with the art will recognize various alternative designs and embodiments within the scope of the following claims. Various embodiments may have been described as providing advantages or being preferred over other embodiments with respect to one or more desired characteristics, however as one skilled in the art is aware, one or more characteristics may be compromised to achieve desired system attributes, which depend on the specific application and implementation. For example, much of the discussion above is directed toward a PHEV application. However, many of the embodiments described apply to electric vehicle as well. Also, parking gear wheel 44 and pawl 46 are shown applied to gear 26 in FIG. 4. However, parking gear wheel 44 could be applied to any portion of the final drive, including ring gear 20 of transmission 18. Some embodiments are more readily applied to a vehicle having an automatic transmission due to the hardware available on a typical automatic-transmission equipped vehicle. However, such embodiments also apply to a manual transmission and vice versa. These attributes that made have tradeoffs include, but are not limited to: cost, strength, durability, life cycle cost, marketability, ease of use, appearance, weight, packaging, size, serviceability, manufacturability, ease of assembly, etc. Embodiments described herein that are characterized as less desirable than other embodiments or prior art implementations with respect to one or more characteristics are not outside the scope of the disclosure and may be desirable for particular applications.

What is claimed:

1. A method to control charging of batteries onboard a vehicle, the method comprising: preventing charging of the batteries via an external power supply when the vehicle is in a condition other than a parked condition.

2. The method of claim 1 wherein the vehicle has a receptacle coupled to the batteries via a battery charger, the battery charger has a relay preventing charging when open and allowing charging when closed, and the step of preventing charging of the batteries comprises opening the relay.

3. The method of claim 1 wherein the vehicle further comprises:
a battery charger coupled to the batteries;
a receptacle electrically coupled to the battery charger;
an access door coupled to the vehicle proximate the receptacle; and
an electronically-actuated latch coupled to the vehicle proximate the access door, the latch having a locked position preventing the access door from opening and an unlocked position in which the latch allows the access door to be opened,
wherein the step of preventing charging comprises commanding the electronically-actuated latch to assume the locked position.

4. The method of claim 1 wherein the vehicle is in a parked condition when a parking brake coupled to the vehicle is set.

5. The method of claim 1 wherein the vehicle further comprises:
an electric motor coupled to the batteries;
a driveline coupled to the electric motor;
wheels coupled to the driveline; and
a parking brake adapted to restrain at least one wheel from rotating when the parking brake is applied; and
the vehicle is in a parked condition when the parking brake is applied.

6. The method of claim 5 wherein the parking brake is mechanically actuated.

7. The method of claim 5 wherein the parking brake is electrically actuated.

8. The method of claim 1 wherein the vehicle further comprises:
an electric motor coupled to the batteries;
a driveline coupled to the electric motor;
a parking gear wheel coupled to the driveline;
a pawl adapted to engage with the parking gear wheel; and
a gear shift selector coupled to an actuating the pawl, the gear shift selector having a park position which actuates the pawl to engage with the parking gear wheel; and
the vehicle is in a parked condition when the pawl is engaged with the parking gear wheel.

9. A vehicle having a system to charge batteries onboard the vehicle, the vehicle comprising:
a battery charger coupled to the batteries;
a receptacle electrically coupled to the battery charger;
an electronic control unit electronically coupled to the battery charger and the vehicle, the electronic control unit preventing charging of the battery via an external power supply when the vehicle is in a condition other than a parked condition.

10. The vehicle of claim 9, comprising:
an electric motor coupled to the batteries;
a transmission coupled to the electric motor;
a parking gear wheel coupled to the transmission; and
a pawl actuated by a gear shift selector, the pawl adapted to engage with the parking gear wheel to prevent rotation of the transmission when the gear shift selector is in a park selection;
wherein the electronic control unit is also electronically coupled to the gear shift selector and the electronic control unit determines that the vehicle is in the parked condition when the gear shift selector is in the park selection.

11. The system of claim 9, the vehicle comprising:
an electric motor coupled to the batteries;
a final drive coupled to the electric motor;
wheels coupled to the final drive; and
a parking brake adapted to restrain at least one wheel from rotating when the parking brake is applied,
wherein the parking brake is electronically coupled to the electronic control unit and the electronic control unit determines that the vehicle is in the parked condition when the parking brake is applied.

12. The system of claim 9, further comprising:
an access door coupled to the vehicle proximate the receptacle; and
a latch proximate to and cooperating with the access door, the latch having a lock position in which the latch prevents the access door from opening and an unlocked position in which the latch allows movement of the access door, the latch electronically coupled to the electronic control unit,
wherein the electronic control unit prevents charging by commanding the latch to the lock position, thereby preventing access to the receptacle by an external power supply cord.

13. The system of claim 9, wherein the battery charger has a relay which allows charging when the relay is closed and prevents charging when the relay is open; and the preventing charging comprises opening the relay.

14. The system of claim 9, further comprising:
a charge indicator light electronically coupled to the electronic control unit, the charge indicator light indicating whether charging is occurring.

15. The system of claim 9, further comprising:
an audible charge indicator electronically coupled to the electronic control unit, the audible charge indicator indicating whether charging is occurring.

16. The system of claim 10, further comprising: an internal combustion engine coupled to the transmission.

17. A method to control charging of batteries onboard a vehicle, the method comprising: preventing coupling of an external power supply cord with a receptacle coupled to the vehicle when the vehicle is in other than a parked condition.

18. The method of claim 17 wherein the vehicle has an access door proximate the receptacle, the access door having an electronically-actuated latch adapted to lock the access door; and the step of preventing coupling comprises commanding the latch to assume a locked position, thereby preventing coupling of an external power supply cord with the receptacle.

19. The method of claim 17 wherein the vehicle is determined to be in a parked condition when a parking brake is applied to a wheel of the vehicle restraining the wheel from rotating.

20. The method of claim 17 wherein the vehicle is determined to be in a parked condition when a gear shift selector coupled to the vehicle is in park.
